(19) United States
(12) Patent Application Publication
(10) Pub. No.: US 2026/0309280 A1
(43) Pub. Date: Oct. 8, 2026

(54) Method and Apparatus for Providing Supplemental Cooling to a Mechanical Refrigeration System

(71) Applicant: Air Products and Chemicals, Inc., Allentown, PA (US)

(72) Inventor: Jon P. Trembley, Surrey (GB)

(73) Assignee: Air Products and Chemicals, Inc., Allentown, PA (US)

(21) Appl. No.: 19/171,522

(22) Filed: Apr. 7, 2025

(51) Int. Cl. F17C 7/04

(52) U.S. Cl. CPC F17C 7/04

(57) ABSTRACT

Additional refrigeration duty is provided as required to a mechanical refrigeration process used to cool a coolant used in an air conditioning system, primarily for a data center, in which heat is rejected to the ambient air using air-cooled condenser units. In situations where additional and/or supplemental refrigeration is required, such as hot weather events which cause sub-optimal cooling, cold and/or dry gas is added into air passing through the air-cooled condenser units of the existing mechanical refrigeration process to provide the additional refrigeration duty. The cold and/or dry gas may be produced by vaporizing a liquid cryogen.

### FIELD OF THE INVENTION

The present invention is in the technical field of mechanical refrigeration and relates specifically to a process and apparatus for providing refrigeration duty, including additional and/or supplementary refrigeration duty, primarily for a data center cooling system.

### BACKGROUND OF THE INVENTION

Data centers are facilities that house computer systems and associated components designed to support the storage, processing, and dissemination of data and applications. Recently, there has been increased demand in the work performed by the computer systems housed in data centers due to advancements in cloud computing, artificial intelligence (AI) and crypto-mining. Since work performed by computer systems generates heat, temperature management of data centers is an important task. However, it is becoming increasingly difficult to ensure optimal working conditions, especially when extreme environmental conditions occur. If temperatures exceed certain thresholds, performance can decline. If computer components overheat, damage can occur, which disrupts operations. Prolonged exposure to high temperatures can also reduce the lifespan of hardware.

The main components of a data center are: servers (primary computing devices that process and manage data); storage devices (to store large volumes of data); networking equipment (such as routers, switches, and other components that connect the various devices within the data center and enable them to communicate with each other); and cooling systems (including air conditioning, ventilation, and in some cases liquid cooling, that maintain optimal temperature and humidity levels within the facility to prevent overheating and equipment failure). In addition to these components, data centers also require backup power sources, such as generators or uninterruptible power supplies (UPS), to ensure that operations continue without disruption in the event of a power outage.

It is estimated that there are presently around 11,000 data center locations worldwide. A number of particularly large data centers are based in normally temperate regions of the world where hot weather conditions are now becoming more frequent, especially during summer months, which impedes performance. Due to the sheer size, infrastructure and time taken to build, it is not an option to simply relocate these data centers.

Data center cooling systems maintain the ideal operating environment for all of the equipment in a data center. The ideal temperature of air being drawn into servers to cool the interior components is between 18° C. and 27° C., with a relative humidity between 40% and 60%. During hot weather events, it becomes increasingly difficult to maintain the ideal temperature. It would therefore be useful to provide improved systems, as well as systems which can be retrofitted to existing systems, to provide additional refrigeration when required. Options like the expansion of existing refrigeration systems used within data centers is often not possible, particularly as there can be limitations to the amount of additional electricity available. Water use is another option that may be considered, but with environmental and sustainability pressures on reduction of water use, this is also not always possible.

U.S. Pat. No. 11,596,087B discloses a data center that is cooled using a refrigerant induction pipe surrounding regions of the data center. The refrigerant is preferably liquid nitrogen. Within the regions of the data center surrounded by the refrigerant induction pipe, computer systems are present within cylindrical racks on rotating devices. Within the racks are temperature sensors that monitor the internal temperature of the racks. Rotation of the cylindrical rack allows the rack to receive uniform cooling from the refrigerant induction pipe irrespective of the distance between the rack and the pipe. When the internal temperature of a rack increases above a set threshold, the speed at which the rack is rotated is increased. Alternatively, if the internal temperature of a rack falls below a set temperature, the speed at which the rack is rotated is decreased. The data center allows computer equipment to be operated at cryogenic temperatures for optimal power consumption.

U.S. Pat. No. 11,882,677B discloses a transportable waterborne data facility comprising a data center housing computer systems and a marine vessel comprising a heat exchange system which supports a closed loop water-based cooling system. Distribution units pump water-based coolant to the data center modules cooling units where it absorbs heat generated by the computing systems. The heat generated by the computer systems is absorbed by the closed loop water-based cooling system at cooling units and the hot coolant is cooled by heat exchange with naturally cold water pumped from the marine vessel.

WO2024/178312A discloses a system for cooling data centers which lowers the energy carbon footprint. The system includes at least one electronics cabinet coupled to a recirculating closed loop nitrogen gas pipe which recirculates nitrogen gas. The nitrogen gas pipe enters a heat exchanger tank filled with liquid nitrogen. Warm nitrogen gas in the closed loop pipe produced by the electronics cabinet enters into the heat exchanger tank and vaporises the cold liquid nitrogen, which cools the closed loop nitrogen gas. Outlet piping coupled to the top portion of the heat exchanger allows the vaporised liquid nitrogen to escape the heat exchanger and be fed to an engine, which is coupled to a generator. Energy from the vapourised nitrogen is utilised to drive the engine, providing rotary motion to the generator to produce electricity. The vaporised nitrogen exiting the engine is then fed to a condenser, which produces cold liquid nitrogen that can be fed back into the heat exchanger. The system described in WO2024/178312A does not provide additional refrigeration duty.

There is still a need generally for improved systems, as well as systems that can be retrofitted to existing refrigeration systems, to supply additional cooling for data centers, particularly in instances where hot weather events can be foreseen which might impede work performed by the housed computer hardware.

### SUMMARY OF THE INVENTION

According to a first aspect of the invention there is provided a process for providing additional refrigeration duty in a closed loop mechanical refrigeration cycle for cooling a first coolant circulating in a closed loop cooling circuit, said process comprising: cooling the first coolant by heat exchange against a first refrigerant circulating in the closed loop mechanical refrigeration cycle in which the first refrigerant is evaporated by heat exchange against the first coolant; condensing the first refrigerant by heat exchange against air in at least one air-cooled condenser unit in the closed loop mechanical refrigeration cycle; and as required, adding cold and/or dry gas into the air passing through the air-cooled condenser unit to provide the additional refrigeration duty for condensing the first refrigerant.

The process of the first aspect provides additional refrigeration duty as required during periods where an existing closed loop mechanical refrigeration cycle is not able to adequately cool a coolant circulating in a closed loop cooling circuit. In embodiments where the process is used in a data center, the closed loop mechanical refrigeration cycle is used to cool a coolant which in turn is used to cool air within the data center. In the present invention, the coolant typically comprises water and/or glycol. Other coolants may comprise dielectric fluids. In preferred embodiments, the coolant is water.

There are various techniques employed to cool data centers that are known to the skilled person. The most common method which forms the basis for many data center cooling strategies is air cooling. The main differences between air cooling systems are in how they control airflow, which can be categorised into three types: room-based, row-based and rack-based. Room-based air-cooling systems are the most commonly used systems for small and medium sized data centers and make use of Computer Room Air Conditioning (CRAC) units to distribute chilled air into the equipment room. CRAC units are typically self-contained air conditioning units that work by recirculating air from a space needing to be conditioned by using fans to draw hot air in before passing it over a cooling coil, where it is cooled. The cooled air is then blown back into the room. The cooling process of the coil uses a direct expansion system and a refrigerant vapour compression cycle to produce the cooling capacity necessary. The refrigeration liquid in the cooling coil pipework of the CRAC unit absorbs and transfers the heat from the hot air passing over it.

The distribution of chilled air can be mainly categorized into top and bottom air supply. Top air supply sends cold air to the room through air supply vents. Bottom air supply pushes cool air through raised floor spaces to enter the room via perforated tiles. Bottom supply has a better cooling performance and is more often used in data centers. Many room-based systems also incorporate a hot and cold aisle configuration to better control airflow and target the equipment, helping conserve energy and lower costs.

For large data centers, where cooling loads are on the order of megawatts of refrigeration, chiller-based systems with a computer room air handler (CRAH) are typically used. A chiller-based system utilises a coolant as a secondary cooling medium i.e., a refrigeration cycle first produces chilled coolant which in turn is used to cool air within the data center.

CRAH units work by recirculating air from a data hall, using fans to draw in hot air which is then passed over a coil containing the chilled coolant. The hot air is cooled before being blown back into the data hall. The coolant absorbs the heat from the hot air in the CRAH units and is then transferred to chillers for reconditioning in a cooling plant typically located outside of the data center. In the cooling plant, heat is removed from the hot coolant using a refrigeration system.

A typical refrigeration system is a continuous and closed-loop refrigeration cycle involving four key phases: evaporation, compression, condensation, and expansion. The term “closed-loop refrigeration cycle” refers to any combination of conduits and devices that results in a closed circuit in which all or substantially all refrigeration fluid circulates through the circuit.

A typical refrigeration cycle begins in the evaporator with a low-pressure liquid refrigerant absorbing heat from a coolant. As the refrigerant absorbs heat, it changes state from a liquid to a vapour. Next, the vapourised refrigerant is fed to a compressor. In this step, the compressor increases the pressure of the vapourised refrigerant, raising its temperature. The high-pressure, high temperature vapourised refrigerant then moves to the condenser. Upon reaching the condenser coils, the hot vapourised refrigerant releases heat to the surroundings. As it loses heat, the refrigerant transitions from a gaseous state back into a liquid. Finally, the liquid refrigerant passes through an expansion valve or device, where it experiences a pressure drop. The sudden reduction in pressure cools the refrigerant further, and the low-pressure liquid refrigerant returns to the evaporator to begin another cycle.

Refrigerants that may be used in the closed loop mechanical refrigeration cycle include hydrofluoroolefins (HFOs), which are unsaturated organic compounds composed of hydrogen, fluorine and carbon. Unlike traditional hydrofluorocarbons (HFCs) and chlorofluorocarbons (CFCs), which are saturated, HFOs are olefins. HFO refrigerants are advantageous because they have a low global warming potential (GWP) and no ozone depletion potential (ODP). Alternative refrigerants to HFOs with low GWP may include ammonia (NH₃). However, the process of the present invention is not limited to any particular refrigerant. Any refrigerant known to the skilled person which is suitable for the present process may be used.

The method of heat rejection in the refrigeration cycle defines the type of chilling system used to recondition the coolant. The main three types of chilling system are water-cooled chillers, glycol chillers, and air-cooled chillers. The chilled water supply and return is similar in each configuration.

In water-cooled chillers, the cooling process is managed and created by a water-cooled chiller, which operates like a heat exchanger, using the refrigeration process to transfer heat from the chilled water system to the condenser water system, where the cooling towers will reject it to the atmosphere.

Glycol chillers are similar to water-cooled chillers. The heat removed from the returning coolant is rejected to a glycol loop for transport to the outside atmosphere. The glycol flows to a dry cooler where heat is rejected to the outside atmosphere as fans force outdoor air through the warm glycol-filled coil in the dry cooler.

In air-cooled chillers, the cooling process is managed and created by the air-cooled chiller via the refrigeration process. The heat of refrigerant is rejected to an air-cooled condenser that is typically integrated with the chiller. Air-cooled chillers are typically located outdoors. In preferred embodiments of the invention, the chiller cooling arrangement uses an air-cooled chiller process.

As required, cold and/or dry gas is added into the air passing through the air-cooled condenser unit to provide the additional refrigeration duty for condensing the first refrigerant. Since the process of the present invention uses air-cooled chillers, the ambient environmental temperature and humidity has an impact on the ability of the air-cooled condenser unit to condense the first refrigerant. The process of the present invention is therefore intended to be used primarily for short term situations, such as hot weather events. As such, the additional refrigeration duty can be provided almost instantly upon starting the supplemental refrigeration process and may be used for a few hours (such as about 2 or 3 hours) up to a few days (such as about 2 or 3 days).

In the case of hot weather events, meteorological data can be used to forecast periods where hot weather might cause temperatures to rise above the desired threshold. The set threshold at which the supplemental process would start depends on both the temperature and relative humidity of the surrounding environment.

In some embodiments, the process would be used when the temperature of the surroundings is at least about 34° C., for example at least about 35° C.

In some embodiments, the process would be used when the relative humidity of the surroundings is at least about 60%, for example at least about 65%. High relative humidity can negatively affect the condensing unit by causing increased condensation on the condenser coils, which can reduce the unit's cooling efficiency and potentially lead to icing issues, ultimately impacting the overall performance of the refrigeration system.

The process of the present invention may also be used when a combination of the surrounding temperature and relative humidity causes the existing closed loop mechanical refrigeration cycle to provide sub-optimal performance. This could be when the water concentration in the atmosphere is at least about 20 g/m³, for example at least about 23 g/m³. Combinations of temperature and relative humidity in which the water concentration exceeds these thresholds are shown in Table 1.

TABLE 1

| | | Relative humidity | | | | | | | | | | |
|---|---|---|---|---|---|---|---|---|---|---|---|---|
| Water Concentration | | 100% | 90% | 80% | 70% | 60% | 50% | 40% | 30% | 20% | 10% | 0% |
| | | Concentration in g/m³ | | | | | | | | | | |
| Temperature ° C. | 40 | 51.5 | 46.3 | 41.2 | 36.0 | 30.9 | 25.7 | 20.6 | 15.4 | 10.3 | 5.1 | 0.0 |
| | 39 | 48.9 | 44.0 | 39.1 | 34.3 | 29.4 | 24.5 | 19.6 | 14.7 | 9.8 | 4.9 | 0.0 |
| | 38 | 46.5 | 41.9 | 37.2 | 32.6 | 27.9 | 23.3 | 18.6 | 14.0 | 9.3 | 4.7 | 0.0 |
| | 37 | 44.2 | 39.8 | 35.3 | 30.9 | 26.5 | 22.1 | 17.7 | 13.3 | 8.8 | 4.4 | 0.0 |
| | 36 | 42.0 | 37.8 | 33.6 | 29.4 | 25.2 | 21.0 | 16.8 | 12.6 | 8.4 | 4.2 | 0.0 |
| | 35 | 39.8 | 35.8 | 31.9 | 27.9 | 23.9 | 19.9 | 15.9 | 11.9 | 8.0 | 4.0 | 0.0 |
| | 34 | 37.8 | 34.0 | 30.2 | 26.5 | 22.7 | 18.9 | 15.1 | 11.3 | 7.6 | 3.8 | 0.0 |
| | 33 | 35.8 | 32.3 | 28.7 | 25.1 | 21.5 | 17.9 | 14.3 | 10.8 | 7.2 | 3.6 | 0.0 |
| | 32 | 34.0 | 30.6 | 27.2 | 23.8 | 20.4 | 17.0 | 13.6 | 10.2 | 6.8 | 3.4 | 0.0 |
| | 31 | 32.2 | 29.0 | 25.8 | 22.5 | 19.3 | 16.1 | 12.9 | 9.7 | 6.4 | 3.2 | 0.0 |
| | 30 | 30.5 | 27.5 | 24.4 | 21.4 | 18.3 | 15.3 | 12.2 | 9.2 | 6.1 | 3.1 | 0.0 |

The cold and/or dry gas is added into air passing through the air-cooled condenser unit to provide the additional refrigeration duty for condensing the first refrigerant. The cold and/or dry gas will typically be non-toxic.

In embodiments where the gas is cold, the temperature of the gas added into air passing through the air-cooled condenser unit is typically at a temperature equal to or higher than about −35° C., equal to or higher than about −30° C., or equal to or higher than about −25° C. The temperature of the cold gas is typically no more than about −5° C., or no more than about −10° C., or no more than about −15° C. In one embodiment, the temperature of the cold gas is about −20° C. This temperature ensures adequate additional refrigeration duty is provided whilst preventing the build-up of ice/snow.

Additionally, or alternatively, the gas is dry. The term “dry” in this context means that the gas is at least substantially free of water before being added to the air. The dry gas typically contains no more than about 2 ppm water, for example no more than about 1 ppm water, or no more than about 0.5 ppm water. Addition of a gas that is at least substantially water-free reduces the humidity of the air used to condense the refrigerant, preventing build-up of condensation and increasing efficiency of the closed loop mechanical refrigeration cycle.

The term “added” is intended to mean releasing the cold and/or dry gas into the normal airflow that passes through the air-cooled condenser unit. Thus, in this way the cold and/or dry gas is entrained within the condenser airflow. The cold and/or dry gas is preferably added at a location at or near where air enters the air-cooled condenser unit. Adding the cold and/or dry gas may, for example, be achieved by passing the cold and/or dry gas through at least one nozzle.

The term “air” is intended to refer to gas mixtures having compositions that are at least similar to atmospheric air. Such gas mixtures typically comprise from about 76 mol. % to about 80 mol. % (for example about 78 mol. %) nitrogen and about 19 mol. % to about 23 mol. % (for example about 21 mol. %) oxygen. The gas mixtures usually also comprise about 1 mol. % argon and possibly trace amounts of one or more of gases selected from the group consisting of carbon dioxide, neon, helium, methane, krypton, xenon, and hydrogen. In preferred embodiments, the air passing through the air-cooled condenser unit is the surrounding natural atmospheric, or ambient, air.

The total condenser airflow rate, i.e. the flowrate through all of the condenser units in the system, is typically at least about 100 cubic meters per second (m³/s), or at least about 110 m³/s, or at least about 120 m³/s. The total flow rate of the condenser airflow is typically no more than about 150 m³/s, or no more than about 140 m³/s, or no more than about 130 m³/s. The total flow rate depends on the type and size of the refrigeration system used. In one embodiment, the total condenser airflow rate is about 123.5 m³/s for a 1.6 MW refrigeration system.

To provide an additional 0.5 megaWatt (MW) refrigeration duty to, for example, a 1.6 MW refrigeration system, the flow rate of the cold and/or dry gas added to the total condenser airflow would typically be at least about 0.8 m³/s, or at least about 1 m³/s. The flow rate of the cold and/or dry gas would typically be no more than about 1.6 m³/s, or no more than about 1.4 m³/s. In one embodiment, the flow rate of the cold and/or dry gas added to the total condenser airflow to provide 0.5 MW refrigeration duty is 1.2 m³/s, which is about 1% of the total condenser airflow rate for a 1.6 MW refrigeration system.

To provide an additional 1 MW refrigeration duty to, for example, a 1.6 MW refrigeration system, the flow rate of the cold and/or dry gas added to the total condenser airflow would typically be at least about 2 m³/s, or at least about 2.2 m³/s. The flow rate of the cold and/or dry gas would typically be no more than about 2.8 m³/s, or no more than about 2.6 m³/s. In one embodiment, the flow rate of the cold and/or dry gas added to the total condenser airflow to provide 1 MW refrigeration duty is 2.4 m³/s, which is about 2% of the total condenser airflow rate for a 1.6 MW refrigeration system.

Therefore, the flow rate of the cold and/or dry gas added to the total condenser airflow can be adjusted depending on the type and size of the refrigeration system and to provide the required amount of additional refrigeration duty. In some embodiments, such as where the cold and/or dry gas is added at about 1% of the total condenser airflow rate, the additional refrigeration duty is usually at least about 0.3 MW, or at least about 0.4 MW, and usually no more than about 0.6 MW, or no more than about 0.7 MW. In other embodiments, such as where the cold and/or dry gas added at about 2% of the total condenser airflow rate, the additional refrigeration duty is usually at least about 0.8 MW, or at least about 0.9 MW, and usually no more than about 1.1 MW, or no more than about 1.2 MW.

In preferred embodiments, the cold and/or dry gas is a cold dry gas. The cold dry gas may be produced by vaporising a liquid cryogen. The liquid cryogen may be vaporised by heat exchange against the first coolant prior to cooling the first coolant by heat exchange against the first refrigerant. This produces the cold dry gas and a pre-cooled first coolant. In these embodiments, the first coolant may be at a first temperature (T1) prior to evaporating the first refrigerant and at a second temperature (T2) that is lower than the first temperature (T1) after evaporating the first refrigerant, and the liquid cryogen is used to pre-cool the first coolant when T2 exceeds a particular threshold, for example about 36° C.

The temperature threshold of T2 may change and be defined depending on the particular refrigeration design conditions. Therefore, the T2 temperature threshold may be at least about 33° C., or at least about 34° C., or at least about 35° C.

The temperature T1 of the first coolant prior to evaporating the first refrigerant is typically at a temperature of at least about 25° C., or at least about 30° C., or at least about 35° C. The temperature T1 of the first coolant prior to evaporating the first refrigerant is typically no more than about 50° C., or no more than about 45° C., or no more than about 45° C. In one embodiment, the temperature T1 of the first coolant prior to evaporating the first refrigerant is 36° C.

When T2 exceeds a particular threshold, the liquid cryogen is used to reduce the first temperature (T1) to produce a pre-cooled coolant. The first coolant enters the heat exchanger and is pre-cooled to a temperature of at least about 20° C., or at least about 25° C., or at least about 30° C. The temperature of the pre-coolant leaving the heat exchanger is typically no more than about 45° C., or no more than about 40° C., or no more than about 35° C. In one embodiment, the temperature of the pre-coolant leaving the heat exchanger is 31° C.

Therefore, the difference in temperature between the first coolant entering the heat exchanger and the pre-cooled coolant leaving the heat exchanger is usually at least about 2° C., or at least about 3° C., or at least about 4° C. The difference in temperature between the first coolant entering the heat exchanger and the pre-cooled coolant leaving the heat exchanger is usually no more than about 8° C., or no more than about 7° C., or no more than about 6° C. In one embodiment, the difference in temperature between the first coolant entering the heat exchanger and the pre-cooled coolant leaving the heat exchanger is about 5° C.

Alternatively, the cold dry gas is boil-off gas. Stored liquid cryogen in a typical vacuum insulated cryogen storage tank typically loses ~1% volume/mass per day, producing boil-off gas. Another option to produce cold dry gas is to use an ambient vaporizer or heater to generate a continuous flow of cold dry gas from the stored liquid cryogen over a given period. In either option, the cold dry gas produced could be utilized in the inventive process as required.

The term “liquid cryogen” is intended to mean a liquid having a temperature lower than −70° C. By using a liquid cryogen, a cold gas can easily be produced by vaporization of the liquid cryogen. Furthermore, the liquid cryogen will also be dry, i.e. at least substantially free of water, due to the requirement that the processes used to produce the liquid cryogen are water-free. Therefore, vaporization of the liquid cryogen can produce a gas that is also dry. Preferably, the liquid cryogen is vaporized to produce both a gas that is both cold and dry. Examples of liquid cryogens include liquid nitrogen (LIN), liquid air (LAIR), liquid argon (LAR), liquid hydrogen (LH2), and liquid oxygen (LOX). In preferred embodiments, the liquid cryogen is liquid nitrogen. Liquid nitrogen is advantageous because it is readily available, easy to store, and the product supply and distribution infrastructure already exists. Liquid nitrogen vaporises into gaseous nitrogen (GAN), a non-toxic inert gas that can safely be vented to the atmosphere.

In the present invention, liquid cryogen may be generated on site in a cryogenic air distillation and/or liquefaction unit, or removed from a cryogenic energy storage unit. Alternatively, the liquid cryogen is generated elsewhere and transported to the site. In either option, the liquid cryogen can be stored in a storage tank until ready for use. As stored liquid cryogen typically loses ~1% volume/mass per day, on site generation and/or transported liquid cryogen can be used to maintain an adequate amount of liquid cryogen so that the supplemental process of the present invention can be used as required. The liquid cryogen lost during storage may be utilized for other process where required. In embodiments where the process is used for a data center, the amount of stored liquid cryogen would typically be at least 100 tonnes, or at least 150 tonnes, e.g., about 200 tonnes or more.

The flow rate of coolant in the process is typically at least about 20 liters per second (l/s), or at least about 22 l/s, or at least about 24 l/s. The flow rate of the coolant is typically no more than about 30 l/s, or no more than about 28 l/s, or no more than about 26 l/s. The flow rate depends on the type and size of the refrigeration system used. In one embodiment, the flow rate of the coolant is about 26 l/s for a change in temperature of the coolant of 15° C.

To provide an additional 0.5 MW refrigeration duty to, for example, a 1.6 MW refrigeration system, the flow rate of the cryogen into the heat exchanger would typically be at least about 1 kilogram per second (kg/s), or at least about 1.2 kg/s. The flow rate of the cryogen into the heat exchanger would typically be no more than about 1.8 kg/s, or no more than about 1.6 kg/s. In one embodiment, the flow rate of the cryogen into the heat exchanger to provide 0.5 MW refrigeration duty is about 1.4 kg/s for a 1.6 MW refrigeration system.

To provide an additional 1 MW refrigeration duty to, for example, a 1.6 MW refrigeration system, the flow rate of the cryogen into the heat exchanger would typically be at least about 2.4 kg/s, or at least about 2.6 kg/s. The flow rate of the cryogen into the heat exchanger would typically be no more than about 3.2 kg/s, or no more than about 3 kg/s. In one embodiment, the flow rate of the cryogen into the heat exchanger to provide 1 MW refrigeration duty is about 2.8 kg/s for a 1.6 MW refrigeration system.

The rate at which liquid cryogen is used in the process is readily calculated by the skilled person and may be at least 5 tonnes/h, or at least 10 tonnes/h, or at least 20 tonnes/h or at least 30 tonnes/h, depending on the size and/or capacity of the refrigeration system and the data center.

According to a second aspect of the invention, there is provided an apparatus for providing additional refrigeration duty in a closed loop mechanical refrigeration cycle for cooling a first coolant circulating in a closed loop cooling circuit, said apparatus comprising: a closed loop mechanical refrigeration cycle comprising: an evaporator configured to evaporate expanded refrigerant by heat exchange against a first coolant circulating in a closed loop cooling circuit to produce evaporated refrigerant, said evaporator in fluid flow communication with a compressor configured to compress the evaporated refrigerant to produce compressed refrigerant, said compressor in fluid flow communication with an air-cooled condenser unit configured to condense the compressed refrigerant by heat exchange against air to produce condensed refrigerant, said air-cooled condenser unit in fluid flow communication with an expander configured to the expand the condensed refrigerant to produce expanded refrigerant, said expander being in fluid flow communication with the evaporator; a source of cold and/or dry gas; and at least one nozzle in fluid flow communication with the source of cold and/or dry gas for adding cold and/or dry gas into air passing through the air-cooled condenser unit.

In preferred embodiments, the cold and/or dry gas is a cold dry gas and the source of cold dry gas is a heat exchanger located upstream of the evaporator and configured to vaporize a liquid cryogen against the first coolant prior to the first coolant being fed to the evaporator. In these embodiments, the apparatus preferably further comprises a unit for supplying liquid cryogen, said unit being in fluid flow communication with the heat exchanger. The unit may be a unit for generating and/or storing liquid cryogen. For example, the unit may be a distillation and/or liquefication unit, or a cryogenic energy storage unit. Alternatively, or additionally, the unit may be a cryogenic storage tank.

In preferred embodiments, the closed loop cooling circuit is configured and located to cool at least a section of a data center. Preferably, the closed loop cooling circuit is in fluid flow communication with one or more CRAH units located within the data center.

The apparatus of the second aspect may be used for the process of the first aspect.

According to a third aspect of the invention, there is provided a data center comprising computer equipment and an apparatus according to the second aspect for air-cooling said computer equipment. The data center typically comprises at least one enclosed section that houses the computer equipment, whilst the apparatus of the second aspect is typically located on the outside of the enclosed section of the data center and exposed to the ambient air. The data center will also typically house one or more CRAH units in fluid flow communication with the apparatus of the second aspect.

The foregoing and other features of the invention and advantages of the present invention will become more apparent in light of the following detailed description of particular embodiments, as illustrated in the accompanying figures. As will be realized, the invention is capable of modifications in various aspects, all without departing from the invention.

Accordingly, the drawings and the description are to be regarded as illustrative in nature, and not as restrictive.

### BRIEF DESCRIPTION OF DRAWINGS

FIG. 1 is a diagram of a typical process for cooling a data center.

FIG. 2 is a process flow diagram of an existing closed-loop mechanical refrigeration process for cooling a first coolant.

FIG. 3 is a process flow diagram an embodiment of the present invention in which additional refrigeration duty may be provided to the existing closed-loop mechanical refrigeration process of FIG. 2.

FIG. 4 is a process flow diagram of a reference simulation of an air-cooled condenser.

FIG. 5 is a process flow diagram of a simulation of an embodiment of the present invention in which GAN is added to the condenser airflow to the air-condenser shown in FIG. 4.

FIG. 6 is a process flow diagram of a reference simulation of an existing closed-loop mechanical refrigeration process for cooling a first coolant.

FIG. 7 is a process flow diagram of a simulation of an embodiment of the present invention in which additional refrigeration duty is provided to the existing closed-loop mechanical refrigeration process of FIG. 6.

### DETAILED DESCRIPTION OF THE INVENTION

The method and apparatus of this invention will be described in detail with reference to the drawings.

Prior to describing the invention in further detail, the terms used in this application are defined as follows unless otherwise indicated. In addition, it should be understood that this invention is not limited to particular embodiments described, as such may, of course, vary within the scope of the appended claims. It is also to be understood that the terminology used herein is for the purpose of describing particular embodiments only, and is not intended to be limiting, since the scope of the present invention will be limited only by the appended claims.

Unless clear from the context or defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

It is noted that, as used herein and in the appended claims, the singular forms “a”, “an”, and “the” include the plural forms unless the context clearly dictates otherwise. It is further noted that the claims may be drafted to exclude any optional element. As such, this statement is intended to serve as antecedent basis for use of such exclusive terminology as “solely”, “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

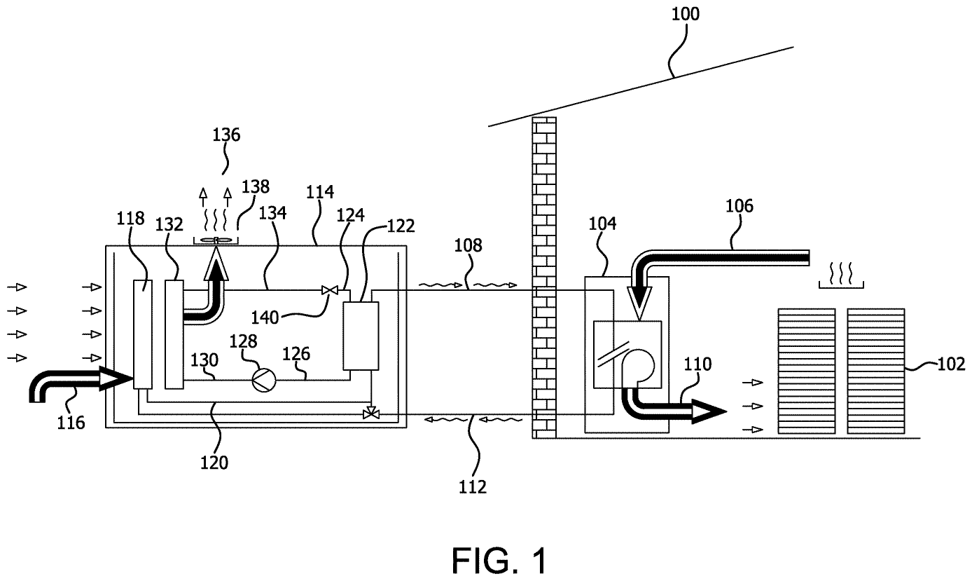

In FIG. 1, there is depicted a typical process for cooling a data center 100 with computer servers 102 and a CRAH unit 104. Heat generated from the computer servers 102 produces warm air 106, which is drawn into the CRAH unit 104. The warm air 106 is cooled by heat exchange with chilled water 108 as a coolant, producing cooled air 110 and warm water 112. The cooled air 110 is then blown out of the CRAH unit 104 to cool the computer servers 102.

The warm water 112 is piped to a cooling plant 114, which is located outside of the data center 100. In the cooling plant 114, heat is removed from the warm water 112 by heat exchange with outside ambient air 116 in a cooling coil 118 to produce cooled water 120. The cooled water 120 then enters an evaporator 122 and is cooled against a refrigerant in a closed loop refrigeration cycle to produce chilled water 108.

In the closed loop refrigeration cycle, a low-pressure liquid refrigerant 124 absorbs heat from the cooled water 120 in the evaporator 122 to produce vaporized refrigerant 126 and chilled water 108. The vaporized refrigerant 126 is then compressed in a compressor 128 to produce warm compressed refrigerant 130. The warm compressed refrigerant 130 is condensed in a condenser 132 by heat exchange with the outside ambient air 116 to produce condensed refrigerant 134. During this process, the warm compressed refrigerant 130 transfers heat to the outside ambient air 116 blown over the condenser 132 to produce warm air 136, which is blown outside back to the ambient environment using a fan 138. The condensed refrigerant 134 is passed through an expansion valve 140 to produce low-pressure liquid refrigerant 124 which is fed into the evaporator 122 to begin another cycle.

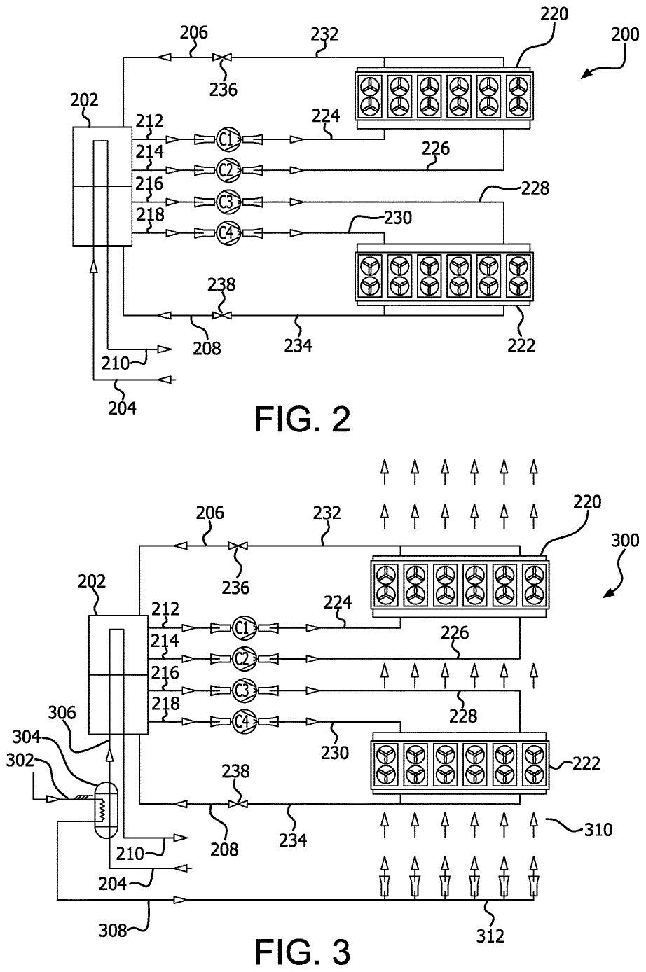

In FIG. 2, there is depicted an existing mechanical refrigeration process 200 for cooling a first coolant. In this case, the first coolant is water which circulates to a CRAH unit in a data center (not shown). The existing mechanical refrigeration process shown in FIG. 2 has two closed loop mechanical refrigeration cycles.

As an exemplary embodiment, water at a temperature of 36° C. may be fed into a shell and tube evaporator 202 at a rate of 25.8 l/s through line 204. The water is passed through the shell and tube evaporator 202 and undergoes heat exchange with vaporized refrigerant from lines 206 and 208 to produce chilled water at a temperature of 21° C. The chilled water exits the shell and tube evaporator 202 through line 210 and is piped to the data center (not shown). The change in temperature between the water entering and exiting the shell and tube evaporator 202 is 15° C.

Heat exchange between the water and the vaporizing refrigerant produces low-pressure refrigerant gas. The low-pressure refrigerant exits the shell and tube evaporator 202 through lines 212, 214, 216, 218. The low-pressure refrigerant from lines 212, 214, 216, 218 is compressed in compressors C1, C2, C3 and C4 respectively to form compressed refrigerant. The compressed refrigerant enters condenser fan units 220, 222 through lines 224, 226 (fed to condenser fan unit 220) and lines 228, 230 (fed to condenser fan unit 222).

Incoming ambient air (not shown) is passed through condenser fan units 220, 222 and is used to condense the refrigerant from lines 224, 226, 228, 230. The incoming air condenses the refrigerant to produce condensed refrigerant.

The condensed refrigerant leaves the condenser fan units 220, 222 through refrigerant return lines 232, 234. Expansion valves 236, 238 produce low-pressure liquid refrigerant, which is fed into a shell and tube evaporator 202 via lines 206, 208.

FIG. 3 shows a process 300 for providing supplemental cooling to the existing mechanical refrigeration process shown in FIG. 2. The features of the process in FIG. 3 that are common to the process of FIG. 2 have been given the same reference numerals. The following is a discussion of the new features in FIG. 3.

When required, for example due to a hot weather event, a liquid nitrogen supply tank (not shown) may feed liquid nitrogen, for example at a rate of 1.4 kg/s, through insulated line 302 to a heat exchanger 304. In this exemplary embodiment, water at a temperature of 36° C. is fed into the heat exchanger 304 at a rate of 25.8 l/s through line 204 and is pre-cooled to 31° C. by indirect heat exchange with the liquid nitrogen, producing gaseous nitrogen at a temperature of −20° C. The pre-cooled water exits the heat exchanger at a temperature of 31° C. through line 306 and is fed into shell and tube evaporator 202. The pre-cooled water is passed through shell and tube evaporator 202 and undergoes heat exchange with the vaporizing refrigerant from lines 206 and 208 to produced chilled water at a temperature of 16° C., which then exits the shell and tube evaporator 202 through line 210. The change in temperature between the water entering the heat exchanger 304 and exiting the shell and tube evaporator 202 is 20° C.

The gaseous nitrogen produced from indirect heat exchange between the liquid nitrogen and water exits the heat exchanger 304 through line insulated line 308 and is added into the airflow 310 passing through condenser fan units 220, 222 via nozzles 312. The combined air and gaseous nitrogen is then safely vented to the atmosphere at a flow rate of 123.5 m³/s.

### Examples

By way of an example of the invention, a simulation of the effect of the invention on a condenser only and a closed loop refrigeration cycle has been performed. The simulation was performed using Aspen Plus® Process Simulation software from Aspen Technology, Inc. In the following tables, “CONVEN” means “condenser vent”.

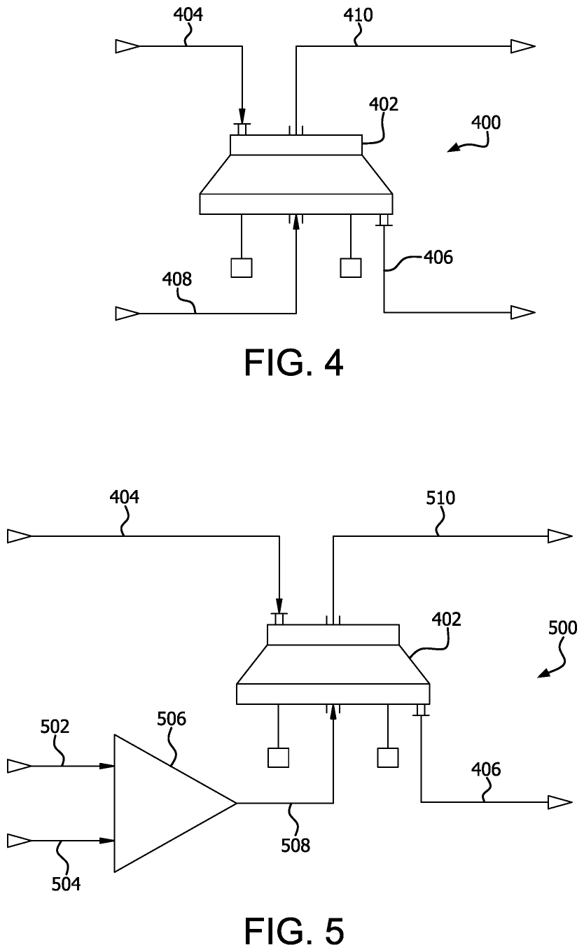

Example 1. A reference condenser system 400 as shown in FIG. 4 was simulated according to the conditions defined in Table 2. In FIG. 4, a condenser unit 402 has R1234ze refrigerant input 404 and R1234ze refrigerant output 406. The condenser unit 402 also has air input 408 and air output 410.

TABLE 2

| Defined Parameters | | Units |
|---|---|---|
| Condenser R1234ze Degrees Subcooling | 7 | ° C. |
| R1234ze Condenser Entering Pressure | 14.5 | bar |
| R1234ze Mass Flow Rate | 44895 | kg/hr |
| R1234ze Entering Vapour Fraction | 1 | — |
| Condenser Air Pressure | 1.01325 | bar |
| Ambient Air Temperature | 32.5 | ° C. |
| Air Relative Humidity | 77 | % |
| Condenser Air Flow rate | 123.5 | m3/s |

The heat and mass balance results of the simulation are shown in Table 3. Ambient air at 32.5° C. enters the condenser and cools refrigerant that enters the condenser at a temperature of about 65.4° C. The refrigerant is cooled to about 58.4° C. and the air leaves the condenser at about 45.0° C. Thus, the refrigerant is cooled by about 7° C.

TABLE 3

| | AIR IN | AIR OUT | R1234ze IN | R1234ze OUT | Units |
|---|---|---|---|---|---|
| From | | CONDENSER | | CONDENSER | |
| To | CONDENSER | | CONDENSER | | |
| Stream Class | CONVEN | CONVEN | CONVEN | CONVEN | |
| Phase | Vapor Phase | Vapor Phase | Vapor Phase | Liquid Phase | |
| Temperature | 32.50 | 44.98 | 65.39 | 58.39 | ° C. |
| Pressure | 1.01325 | 1.01325 | 14.5 | 14.5 | bar |
| Molar Vapor Fraction | 1 | 1 | 1 | 0 | |
| Molar Liquid Fraction | 0 | 0 | 0 | 1 | |
| Molar Solid Fraction | 0 | 0 | 0 | 0 | |
| Mass Vapor Fraction | 1 | 1 | 1 | 0 | |
| Mass Liquid Fraction | 0 | 0 | 0 | 1 | |
| Mass Solid Fraction | 0 | 0 | 0 | 0 | |
| Molar Enthalpy | −1.18 | −1.09 | −190.69 | −194.62 | kcal/mol |
| Mass Enthalpy | −40.91 | −37.89 | −1672.13 | −1706.52 | kcal/kg |
| Molar Entropy | 1.32 | 1.60 | −53.24 | −64.74 | cal/mol-K |
| Mass Entropy | 0.05 | 0.06 | −0.47 | −0.57 | cal/gm-K |
| Molar Density | 0.04 | 0.04 | 0.52 | 9.02 | kmol/cum |
| Mass Density | 1.15 | 1.11 | 58.75 | 1028.97 | kg/cum |
| Enthalpy Flow | −20.93 | −19.38 | −75.07 | −76.61 | MMkcal/hr |
| Average MW | 28.86 | 28.86 | 114.04 | 114.04 | |
| Mass Flows | 511541.01 | 511541.01 | 44895 | 44895 | kg/hr |
| HFO-1-01 | 0 | 0 | 44895 | 44895 | kg/hr |
| AIR | 0 | 0 | 0 | 0 | kg/hr |
| NITRO-01 | 380577.55 | 380577.55 | 0 | 0 | kg/hr |
| OXYGE-01 | 116513.72 | 116513.72 | 0 | 0 | kg/hr |
| ARGON | 6614.32 | 6614.32 | 0 | 0 | kg/hr |
| CARBO-01 | 3052.76 | 3052.76 | 0 | 0 | kg/hr |
| WATER | 4782.66 | 4782.66 | 0 | 0 | kg/hr |
| Volume Flow | 444600 | 462755.10 | 764.17 | 43.63 | cum/hr |
| Mole Flows | 17726.97 | 17726.97 | 393.67 | 393.67 | kmol/hr |

The results from the simulation relating to the condenser only are shown in Table 4. The heat duty of the condenser required to cool the refrigerant by 7° C. is about 1795.8 kW.

TABLE 4

| Condenser | | | Units |
|---|---|---|---|
| | Inlet | Outlet | |
| Hot stream | R1234ze IN | R1234ze OUT | |
| Temperature | 65.39 | 58.39 | ° C. |
| Pressure | 14.5 | 14.5 | bar |
| Vapor Fraction | 1 | 0 | |
| Cold Stream | AIR IN | AIR OUT | |
| Temperature | 32.5 | 44.98 | ° C. |
| Pressure | 1.01325 | 1.01325 | bar |
| Vapor Fraction | 1 | 1 | |
| Heat Duty | 1795.80 | | kW |

Example 2. The same condenser unit was simulated according to the conditions shown in Table 2, with an air and GAN mix added to the condenser airflow, as shown in the system 500 of FIG. 5. The features of the simulation in FIG. 5 that are common to the simulation shown in FIG. 4 have been given the same reference numerals. In FIG. 5, a mixer 506 has an air input 502 and a GAN input 504 to produce an air/GAN mixture input 508 into the condenser 402 and an air/GAN output 510 from the condenser 402.

In this simulation the temperature of the air/GAN output was fixed to match the air output from the simulation shown in FIG. 4, which includes the condenser with no air/GAN. This simulation shows the effect of adding a mixture of air and GAN into the airflow of the condenser. The heat and mass balance results of the simulation are shown in Table 5.

Ambient air at 32.5° C. is mixed with GAN at −20° C. and the mixture enters the condenser at about 31.9° C., cooling the refrigerant that enters the condenser at a temperature of about 65.4° C. The refrigerant is cooled to about 53.9° C. and the air/GAN mixture leaves the condenser at 45.0° C. Thus, the refrigerant has been cooled by 11.5° C.

TABLE 5

| Description | | | | | | | |
|---|---|---|---|---|---|---|---|
| From | MIX | | | | | | |
| To | CONDENSER | MIX | CONDENSER | MIX | CONDENSER | CONDENSER | |
| Stream Class | CONVEN | CONVEN | CONVEN | CONVEN | CONVEN | CONVEN | Units |
| Phase | Vapor Phase | Vapor Phase | Vapor Phase | Vapor Phase | Vapor Phase | Liquid Phase | ° C. |
| Temperature | 31.89 | 32.50 | 44.98 | −20.00 | 65.39 | 53.86 | |
| Pressure | 1.01 | 1.01 | 1.01 | 4.01 | 14.50 | 14.50 | bar |
| Molar Vapor | 1 | 1 | 1 | 1 | 1 | 0 | |
| Fraction | | | | | | | |
| Molar Liquid | 0 | 0 | 0 | 0 | 0 | 1 | |
| Fraction | | | | | | | |
| Molar Solid | 0 | 0 | 0 | 0 | 0 | 0 | |
| Fraction | | | | | | | |
| Mass Vapor | 1 | 1 | 1 | 1 | 1 | 0 | |
| Fraction | | | | | | | |
| Mass Liquid | 0 | 0 | 0 | 0 | 0 | 1 | |
| Fraction | | | | | | | |
| Mass Solid | 0 | 0 | 0 | 0 | 0 | 0 | |
| Fraction | | | | | | | |
| Molar Enthalpy | −4900162.58 | −4942329.59 | −4517739.67 | −1310033.50 | −798398294.49 | −815821182.66 | J/kmol |
| Mass Enthalpy | −169.87 | −171.27 | −156.61 | −46.76 | −7000.85 | −7153.63 | kJ/kg |
| Molar Entropy | 5446.59 | 5535.05 | 6674.11 | 16207.25 | −222905.36 | −273818.97 | J/kmol-K |
| Mass Entropy | 188.81 | 191.81 | 231.36 | −578.54 | −1954.57 | −2401.02 | J/kg-K |
| Molar Density | 0.04 | 0.04 | 0.04 | 0.19 | 0.52 | 9.19 | kmol/cum |
| Mass Density | 1.15 | 1.15 | 1.11 | 5.34 | 58.75 | 1047.97 | kg/cum |
| Enthalpy Flow | −24412.57 | −24336.81 | −22507.35 | −75.77 | −87306.47 | −89211.70 | kW |
| Average MW | 28.85 | 28.86 | 28.85 | 28.01 | 114.04 | 114.04 | |
| Mass Flows | 143.71 | 142.09 | 143.71 | 1.62 | 12.47 | 12.47 | kg/sec |
| HFO-1-01 | 0 | 0 | 0 | 0 | 12.47 | 12.47 | kg/sec |
| AIR | 0 | 0 | 0 | 0 | 0 | 0 | kg/sec |
| NITRO-01 | 107.34 | 105.72 | 107.34 | 1.62 | 0 | 0 | kg/sec |
| OXYGE-01 | 32.36 | 32.36 | 32.36 | 0 | 0 | 0 | kg/sec |
| ARGON | 1.84 | 1.84 | 1.84 | 0 | 0 | 0 | kg/sec |
| CARBO-01 | 0.85 | 0.85 | 0.85 | 0 | 0 | 0 | kg/sec |
| WATER | 1.33 | 1.33 | 1.33 | 0 | 0 | 0 | kg/sec |
| Mass Fractions | 124.70 | 123.50 | 130.05 | 0.30 | 0.21 | 0.01 | cum/sec |
| Volume Flow | | | | | | | |
| Mole Flows | 4.96 | 4.92 | 4.98 | 0.06 | 0.11 | 0.11 | kmol/sec |

The results from the simulation relating to the condenser only are shown in Table 6.

TABLE 6

| Condenser | | | Units |
|---|---|---|---|
| | Inlet | Outlet | |
| Hot stream | R1234ze IN | R1234ze OUT | |
| Temperature | 65.39 | 53.86 | |
| Pressure | 14.5 | 14.5 | bar |
| Vapor Fraction | 1 | 0 | |
| Cold Stream | AIR IN | AIR OUT | |
| Temperature | 31.89 | 44.98 | |
| Pressure | 1.01325 | 1.01325 | bar |
| Vapor Fraction | 1 | 1 | |
| Heat Duty | 1905.23 | | kW |

As shown in Table 6, the heat duty of the condenser is about 1905.2 KW. The condenser duty has therefore increased by about 109.4 KW compared to the condenser with no air/GAN mixture added to the condenser airflow.

The results relating to the air/GAN mixer are shown in Table 7. Although GAN has been used as the gas to be mixed with air, the combination of temperature and dryness is responsible for the addition duty and increased cooling, therefore a similar effect would be expected regardless of the gas used.

TABLE 7

| AIR/GAN Mixer | | Units |
|---|---|---|
| Intet AIR Temperature | 32.5 | ° C. |
| Intet AIR Pressure | 1.01325 | bar |
| Inlet GAN Temperature | −20 | ° C. |
| Inlet GAN Pressure | 4.01325 | bar |
| Outlet Temperature | 31.89 | ° C. |
| Outlet Pressure | 1.01325 | bar |
| Vapor Fraction | 1 | |

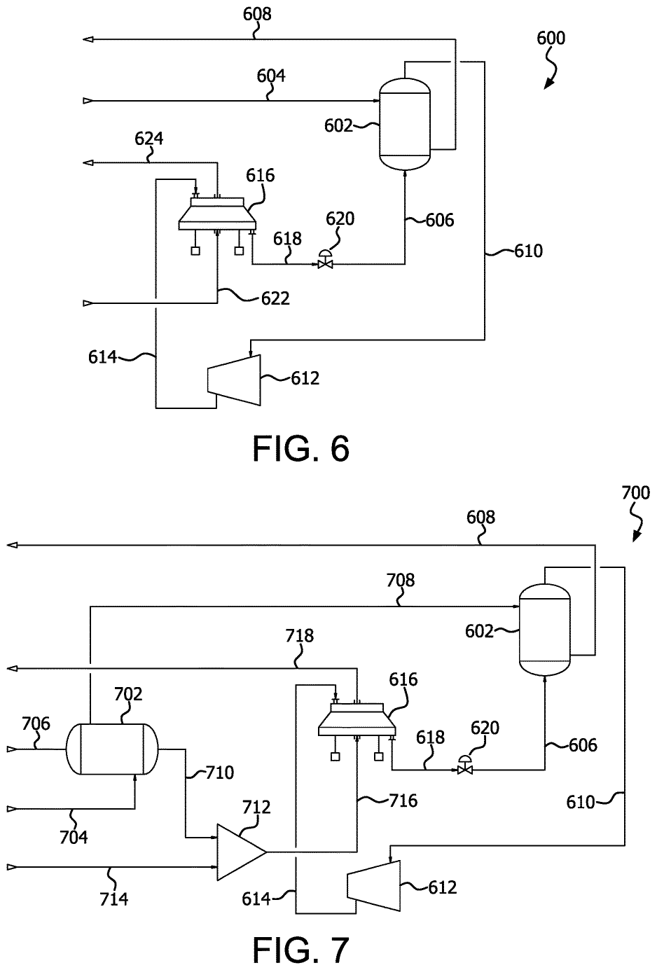

Example 3. A reference closed-loop refrigeration cycle system 600 as shown in FIG. 6 was simulated according to the conditions defined in Table 8. In FIG. 6, an evaporator 602 has a water input 604 and a water output 608. Expanded refrigerant 606 enters the evaporator and exits as evaporated refrigerant 610. Evaporated refrigerant 610 is compressed in a compressor 612 to produce compressed refrigerant 614. A condenser unit 616 has a compressed refrigerant 614 input and a condensed refrigerant 618 output. The condenser unit 616 also has air input 622 and air output 624. The condensed refrigerant 618 is expanded in an expander 620 to produce expanded refrigerant 606.

TABLE 8

| Defined Parameters | | Units |
|---|---|---|
| Evaporator Entering Temperature | 36 | ° C. |
| Evaporator Leaving Temperature | 21.1 | ° C. |
| Evaporator Water Flow rate | 25.8 | L/s |
| Water Pressure | 10 | bar |
| Ambient Air Pressure | 1.01325 | bar |
| Ambient Air Temperature | 32.5 | ° C. |
| Condenser R1234ze Degrees Subcooling | 7 | ° C. |
| Condenser Air Flow rate | 123.5 | m3/s |

The heat and mass balance results of the simulation are shown in Table 9. Water at 36° C. enters the evaporator and is cooled to about 22.1° C. by heat exchange with expanded refrigerant which enters the evaporator at a temperature of about 19.4° C. The refrigerant leaves the evaporator at a temperature of about 33.5° C. and enters the compressor to produce compressed refrigerant. The compressed refrigerant enters the condenser at a temperature of about 76.9° C. and is cooled to about 58.3° C. by air which enters the condenser at about 32.5° C. and leaves the condenser at about 46.2° C. Thus, the refrigerant has been cooled by about 18.6° C. and the water cooled by about 13.9° C.

TABLE 9

| | | AIR OUT | COMP OUT | COND OUT | EVAP OUT |
|---|---|---|---|---|---|
| From | AIR IN | CON- | COMPRESSOR | CONDENSER | EVAPORATOR |
| To | CONDENSER | DENSER | CONDENSER | EXPANDER | COMPRESSOR |
| Phase | Vapor Phase | Vapor Phase | Vapor Phase | Liquid Phase | Vapor Phase |
| Temperature | 32.50 | 46.16 | 76.88 | 58.28 | 33.52 |
| Pressure | 1.01325 | 1.01325 | 14.5 | 14.5 | 4.18 |
| Molar Vapor Fraction | 1 | 1 | 1 | 0 | 1 |
| Molar Liquid Fraction | 0 | 0 | 0 | 1 | 0 |
| Molar Solid Fraction | 0 | 0 | 0 | 0 | 0 |
| Mass Vapor Fraction | 1 | 1 | 1 | 0 | 1 |
| Mass Liquid Fraction | 0 | 0 | 0 | 1 | 0 |
| Mass Solid Fraction | 0 | 0 | 0 | 0 | 0 |
| Molar Enthalpy | 207487.32 | 600916.07 | −799333859.09 | −817058723.01 | −802427078.50 |
| Mass Enthalpy | 7167.09 | 20757.03 | −7009056.75 | −7164479.39 | −7036180.02 |
| Molar Entropy | 691.69 | 1950.93 | −223730.86 | −276072.66 | −224431.00 |
| Mass Entropy | 23.89 | 67.39 | −1961.81 | −2420.78 | −1967.95 |
| Molar Density | 0.04 | 0.04 | 0.65 | 9.03 | 0.18 |
| Mass Density | 1.15 | 1.11 | 74.28 | 1029.43 | 20.58 |
| Enthalpy Flow | 1022.20 | 2960.45 | −87408.78 | −89347.03 | −87747 |
| Average MW | 28.95 | 28.95 | 114.04 | 114.04 | 114.04 |
| Mole Flows | 17735.61 | 17735.61 | 393.67 | 393.67 | 393.67 |
| Mass Flows | 513445.94 | 513445.94 | 44895 | 44895 | 44895 |
| Mass Fractions | | | | | |
| Volume Flow | 444600 | 464525.80 | 604.44 | 43.61 | 2181.66 |

| | EXPAN OUT | H2O OUT | WARM H2O | Units |
|---|---|---|---|---|
| From | EXPANDER | EVAPO- | EVAPO- | |
| To | EVAPORATOR | RATOR | RATOR | |
| Phase | | Liquid Phase | Liquid Phase | ° C. |
| Temperature | 19.41 | 22.06 | 36 | bar |
| Pressure | 4.18 | 10 | 10 | |
| Molar Vapor Fraction | 0.33 | 0 | 0 | |
| Molar Liquid Fraction | 0.67 | 1 | 1 | |
| Molar Solid Fraction | 0.00 | 0 | 0 | |
| Mass Vapor Fraction | 0.33 | 0 | 0 | |
| Mass Liquid Fraction | 0.67 | 1 | 1 | |
| Mass Solid Fraction | 0 | 0 | 0 | |
| Molar Enthalpy | −817058723.01 | −287965970.04 | −286830136.14 | J/kmol |
| Mass Enthalpy | −7164479.39 | −15984788.79 | −15921739.45 | J/kg |
| Molar Entropy | −274324.55 | −168892.18 | −165132.67 | J/kmol-K |
| Mass Entropy | −2405.45 | −9375.09 | −9166.40 | J/kg-K |
| Molar Density | 0.56 | 55.35 | 54.60 | kmol/cum |
| Mass Density | 63.41 | 997.12 | 983.60 | kg/cum |
| Enthalpy Flow | −89347.03 | −405645.18 | −404045.18 | kW |
| Average MW | 114.04 | 18.02 | 18.02 | |
| Mole Flows | 393.67 | 5071.16 | 5071.16 | kmol/hr |
| Mass Flows | 44895 | 91357.02 | 91357.02 | kg/hr |
| Mass Fractions | | | | |
| Volume Flow | 707.99 | 91.62 | 92.88 | cum/hr |

The results from the simulation relating to the condenser and evaporator are shown in Table 10. The heat duty of the condenser required to cool the refrigerant by about 18.6° C. is about 1938.3 KW. The heat duty of the evaporator required to cool the water by about 13.9° C. is about 1600 kW.

TABLE 10

| | Condenser | | Evaporator | | Units |
|---|---|---|---|---|---|
| | Inlet | Outlet | Inlet | Outlet | |
| Hot stream | COMP OUT | COND OUT | WARM H2O | H2O OUT | |
| Temperature | 76.88 | 58.28 | 36 | 22.06 | ° C. |
| Pressure | 14.5 | 14.5 | 10 | 10 | bar |
| Vapor Fraction | 1 | 0 | 0 | 0 | |
| Cold Stream | AIR IN | AIR OUT | EXPAN OUT | EVAP OUT | |
| Temperature | 32.5 | 46.16 | 19.41 | 33.52 | ° C. |
| Pressure | 1.01325 | 1.01325 | 0.33 | 4.18 | bar |
| Vapor Fraction | 1 | 1 | 1 | 1 | |

| | | | |
|---|---|---|---|
| Heat Duty | 1938.25 | 1600 | kW |

The results from the simulation relating to the compressor and the expansion valve are shown in Table 11.

TABLE 11

| Compressor | | Units | Expansion Valve | | Units |
|---|---|---|---|---|---|
| Compressor model | GPSA polytropic | | Outlet Pressure | 4.18 | bar |
| Phase calculations | Two phase calculation | | Pressure Drop | 10.32 | bar |
| Indicated horsepower | 338.25 | kW | Inlet Temperature | 58.27931343 | ° C. |
| Brake horsepower | 338.25 | kW | Outlet Temperature | 19.4145711 | ° C. |
| Net work required | 338.25 | kW | Outlet Vapor Fraction | 0.33336366 | |
| Power loss | 0 | | | | |
| Efficiency | 1 | | | | |
| Mechanical efficiency | 1 | | | | |
| Outlet pressure | 14.5 | bar | | | |
| Outlet temperature | 76.88 | ° C. | | | |
| Isentropic outlet temperature | 74.97 | ° C. | | | |
| Vapor fraction | 1 | | | | |

Example 4. The same closed-loop refrigeration cycle was simulated according to the conditions shown in Table 12, with a LIN heat exchanger producing pre-cooled water coolant and GAN, the GAN being mixed with air and added to the condenser air flow, as shown in the system 700 of FIG. 7. The features of the simulation in FIG. 6 that are common to the simulation shown in FIG. 7 have been given the same reference numerals. In FIG. 7, a heat exchanger 702 has a water input 704 and a LIN input 706. Pre-cooled water 708 and GAN 710 leave the heat exchanger. A mixer 712 has an air input 714 and a GAN 710 input to produce an air/GAN mixture 716. The condenser 616 has an air/GAN mixture 716 input and an air/GAN output 718.

TABLE 12

| Defined Parameters | | Units |
|---|---|---|
| Liquid Nitrogen Pressure | 4.01325 | bar |
| Liquid Nitrogen Vapour Fraction | 0 | — |
| Liquid Nitrogen Heat Exchanger Water Entering Temperature | 36 | ° C. |
| Liquid Nitrogen Heat Exchanger Water Leaving Temperature | 31 | ° C. |
| Evaporator Leaving Temperature | 21.1 | ° C. |
| Evaporator Water Flow rate | 25.8 | L/s |
| Water Pressure | 10 | bar |
| Ambient Air Temperature | 32.5 | ° C. |
| Relative Humidity | 77 | % |
| Condenser R1234ze Degrees Subcooling | 7 | ° C. |
| Condenser Air Flow rate | 123.5 | m3/s |

The heat and mass balance results of the simulation are shown in Table 13. Water at 36° C. enters the heat exchanger and is cooled against LIN which is at a temperature of about −181.7° C., producing pre-cooled water at 31° C. and GAN at −20° C. The pre-cooled water enters the evaporator and is cooled to about 21.1° C. by heat exchange with expanded refrigerant which enters the evaporator at a temperature of about 19.4° C. The difference in temperature between the water entering and exiting the evaporator is about 9.9° C. The refrigerant leaves the evaporator at a temperature of 30° C. and enters the compressor to produce compressed refrigerant. The compressed refrigerant enters the condenser at a temperature of about 73.7° C. and is cooled to about 58.3° C. Thus, the refrigerant has been cooled by about 15.4° C. The GAN produced from the LIN is mixed with air at 32.5° C. to produce an air/GAN mixture at about 31.9° C. which enters the condenser to cool the refrigerant.

TABLE 13

| | AIR GAN | | | COMP OUT | COND OUT | EVAP OUT | |
|---|---|---|---|---|---|---|---|
| From | MIX | AIR IN | AIR OUT | COMPRESSOR | CONDENSER | EVAPORATOR | |
| To | CONDENSER | MIX | CONDENSER | CONDENSER | EXPANDER | COMPRESSOR | |
| Stream Class | CONVEN | CONVEN | CONVEN | CONVEN | CONVEN | CONVEN | |
| Phase | Vapor Phase | Vapor Phase | Vapor Phase | Vapor Phase | Liquid Phase | Vapor Phase | |
| Temperature | 31.89 | 32.50 | 41.27 | 73.65 | 58.28 | 30.00 | |
| Pressure | 1.02 | 1.01 | 1.01 | 14.50 | 14.50 | 4.18 | |
| Molar Vapor Fraction | 1 | 1 | 1 | 1 | 0 | 1 | |
| Molar Lquid Fraction | 0 | 0 | 0 | 0 | 1 | 0 | |
| Molar Solid Fraction | 0 | 0 | 0 | 0 | 0 | 0 | |
| Mass Vapor Fraction | 1 | 1 | 1 | 1 | 0 | 1 | |
| Mass Liquid Fraction | | 0 | 0 | 0 | 1 | 0 | |
| Mass Solid Fraction | 0 | 0 | 0 | 0 | 0 | 0 | |
| Molar Enthalpy | −17965899.60 | −18160897.61 | −17688499.52 | −799747945.88 | −817058723.01 | −802797982.80 | |
| Mass Enthalpy | −611993.07 | −618303.96 | −602543.67 | −7012687.72 | −7164479.39 | −7039432.34 | |
| Molar Entropy | 6485.77 | 6584.60 | 7381.46 | −224919.36 | −276072.66 | −225647.45 | |
| Mass Entropy | 220.93 | 224.18 | 251.44 | −1972.23 | −2420.78 | −1978.62 | |
| Molar Density | 0.04 | 0.04 | 0.04 | 0.67 | 9.03 | 0.18 | |
| Mass Density | 1.17 | 1.17 | 1.14 | 75.90 | 1029.43 | 20.90 | |
| Enthalpy Flow | −89666.40 | −89488.19 | −88183.46 | −63890.94 | −65273.88 | −64134.61 | |
| Average MW | 29.36 | 29.37 | 29.36 | 114.04 | 114.04 | 114.04 | |
| Mole Flows | 17847.28 | 17739.07 | 17947.28 | 267.60 | 287.60 | 287.60 | |
| Mass Flows | 526867.14 | 521034.40 | 526867.14 | 32798.75 | 32798.75 | 32798.75 | |
| NITRO-01 | 373714.30 | 367881.57 | 373714.30 | 0 | 0 | 0 | |
| WATER | 4623.11 | 2623.11 | 4623.11 | 0 | 0 | 0 | |
| HFO-1-01 | 0 | 0 | 0 | 32798.75 | 32798.75 | 32798.75 | |
| AIR | 0 | 0 | 0 | 0 | 0 | 0 | |
| OXYGE-01 | 112626.84 | 112626.84 | 112626.84 | 0 | 0 | 0 | |
| WATER-02 | G | 0 | 0 | 0 | 0 | 0 | |
| ARGON | 6393.66 | 6393.66 | 6393.66 | 0 | 0 | 0 | |
| CARBO-01 | 29509.22 | 29509.22 | 29509.22 | 0 | 0 | 0 | |
| Volume Flow | 448913.39 | 444600.00 | 462774.17 | 432.16 | 31.86 | 1589.60 | |
| | EXPAN OUT | GAN | | | LIN H2O | | |
| From | EXPANDER | LINHX | H2O OUT | LIN | LINHX | WARM H2O | |
| To | EVAPORATOR | MIX | EVAPORATOR | LINHX | EVAPORATOR | LINHX | |
| Stream Class | CONVEN | CONVEN | CONVEN | CONVEN | CONVEN | CONVEN | Units |
| Phase | | Vapor Phase | Liquid Phase | Liquid Phase | Liquid Phase | Linnuit Phase | |
| Temperature | 19.41 | −20.00 | 21.07 | −181.74 | 31.00 | 36.00 | ° C. |
| Pressure | 4.18 | 4,01 | 10.00 | 4.01 | 10.00 | 10.00 | bar |
| Molar Vapor Fraction | 0.33 | 1 | 0 | 0 | 0 | 0 | |
| Molar Lquid Fraction | 0.67 | 0 | 1 | 1 | 1 | 1 | |
| Molar Solid Fraction | 0 | 0 | 0 | 0 | 0 | 0 | |
| Mass Vapor Fraction | 0.33 | 1 | 0 | 0 | 0 | 0 | |
| Mass Liquid Fraction | 0.67 | 0 | 1 | 1 | 1 | 1 | |
| Mass Solid Fraction | 0 | 0 | 0 | 0 | 0 | 0 | |
| Molar Enthalpy | −817058723.01 | −1352292.48 | −288045117.94 | −11270535.30 | −287237351.57 | −286830136.14 | J/kmol |
| Mass Enthalpy | −7164479.39 | −48272.02 | −15983237.74 | −402317.96 | −15944343.89 | −15921739.45 | J/kg |
| Molar Entropy | −274324.55 | −16338.46 | −169164.13 | −102422.08 | −166460.65 | −165132.67 | J/kmol-K |
| Mass Entropy | −2405.45 | −583.22 | −9390.18 | −3656.10 | −9240.11 | −9166.40 | J/kg-K |
| Molar Density | 0.56 | 0.19 | 55.40 | 26.48 | 54.87 | 54.60 | kmol/cum |
| Mass Density | 63.41 | 5.36 | 998.06 | 740.62 | 988.47 | 983.60 | kg/cum |
| Enthalpy Flow | −65273.88 | −78.21 | −405758.08 | −651.84 | −404618.81 | −404045.18 | kW |
| Average MW | 114.04 | 28.01 | 18.02 | 28.01 | 18.02 | 18.02 | |
| Mole Flows | 287.60 | 208.21 | 5071.16 | 208.21 | 5071.16 | 5071.16 | kmol/hr |
| Mass Flows | 32798.75 | 5832.74 | 91357.02 | 5832.74 | 91357.02 | 91357.02 | kg/hr |
| NITRO-01 | 0 | 5832.74 | 0 | 5832.74 | 0 | 0 | kg/hr |
| WATER | 0 | 0 | 91357.02 | 0 | 91357.02 | 91357.02 | kg/hr |
| HFO-1-01 | 32798.75 | 0 | 0 | 0 | 0 | 0 | kg/hr |
| AIR | 0 | 0 | 0 | 0 | 0 | 0 | kg/hr |
| OXYGE-01 | 0 | 0 | 0 | 0 | 0 | 0 | kg/hr |
| WATER-02 | 0 | 0 | 0 | 0 | 0 | 0 | kg/hr |
| ARGON | 0 | 0 | 0 | 0 | 0 | 0 | kg/hr |
| CARBO-01 | 0 | 0 | 0 | 0 | 0 | 0 | kg/hr |
| Volume Flow | 517.24 | 1087.30 | 91.53 | 7.88 | 92.42 | 92.88 | cum/hr |

The results from the simulation relating to the condenser, evaporator and heat exchanger are shown in Table 14. The heat duty of the condenser required to cool the refrigerant by about 15.4° C. is about 1382.9 kW. The heat duty of the evaporator required to cool the pre-cooled water by about 9.9° C. is 1139.3 KW. The heat duty provided by the heat exchanger is about 573.6 kW. The supplemental cooling system is therefore still able to cool and maintain the incoming water temperature. This keeps the current installed refrigeration system operating under design conditions, so maintaining optimum operation with no additional stress, wear or fatigue to the system or components.

TABLE 14

| | Condenser | | Evaporator | | LIN Heat Exchanger | | |
|---|---|---|---|---|---|---|---|
| | Inlet | Outlet | Inlet | Outlet | Inlet | Outlet | Units |
| Hot stream | COMP OUT | COND OUT | WARM H2O | H2O OUT | WARM H2O | LIN H2O | |
| Temperature | 73.65 | 58.28 | 31 | 21.07 | 36 | 31 | ° C. |
| Pressure | 14.5 | 14.5 | 10 | 10 | 10 | 10 | bar |
| Vapor Fraction | 1 | 0 | 0 | 0 | 1 | 1 | |
| Cold Stream | AIR IN | AIR OUT | EXPAN OUT | EVAP OUT | LIN | GAN | |
| Temperature | 31.89 | 41.27 | 19.41 | 30 | −181.74 | −20.00 | ° C. |
| Pressure | 1.01325 | 1.01325 | 4.18 | 4.18 | 4.01325 | 4.01325 | bar |
| Vapor Fraction | 1 | 1 | 0.33 | 1 | 0 | 1 | |

| | | | | |
|---|---|---|---|---|
| Heat Duty | 1382.94 | 1139.27 | 573.63 | kW |

The results from the simulation relating to the compressor and the expansion valve are shown in Table 15.

TABLE 15

| AIR/GAN Mixer | | | Expansion Valve | | |
|---|---|---|---|---|---|
| Inlet AIR | 32.5 | ° C. | Outlet Pressure | 4.18 | bar |
| Temperature | | | | | |
| Inlet AIR Pressure | 1.01325 | bar | Pressure Drop | 10.32 | bar |
| Inlet GAN | −20.00 | ° C. | Inlet Temperature | 58.28 | ° C. |
| Temperature | | | | | |
| Inlet GAN Pressure | 4.01325 | bar | Outlet Temperature | 19.41 | ° C. |
| Outlet Temperature | 31.89 | ° C. | Outlet Vapor | 0.33 | |
| Outlet Pressure | 1.01325 | bar | Fraction | | |
| Vapor Fraction | 1 | | | | |

The present invention is not to be limited in scope by the specific aspects or embodiments disclosed in the example which is intended as an illustration of an aspect of the invention and any embodiments that are functionally equivalent are within the scope of this invention. Various modifications of the invention in addition to those shown and described herein will become apparent to those skilled in the art and are intended to fall within the scope of the appended claims.

1. A process for providing additional refrigeration duty in a closed loop mechanical refrigeration cycle for cooling a first coolant circulating in a closed loop cooling circuit, said process comprising:
cooling the first coolant by heat exchange against a first refrigerant circulating in the closed loop mechanical refrigeration cycle in which the first refrigerant is evaporated by heat exchange against the first coolant;
condensing the first refrigerant by heat exchange against air in at least one air-cooled condenser unit in the closed loop mechanical refrigeration cycle; and
as required, adding cold and/or dry gas into the air passing through the air-cooled condenser unit to provide the additional refrigeration duty for condensing the first refrigerant.

2. The process according to claim 1, wherein the cold and/or dry gas is a cold dry gas.

3. The process according to claim 2, wherein the cold dry gas is produced by vaporizing a liquid cryogen.

4. The process according to claim 2, wherein the cold dry gas is produced by vaporizing a liquid cryogen by heat exchange against the first coolant prior to said cooling the first coolant by heat exchange against the first refrigerant.

5. The process according to claim 4, wherein the first coolant is at a first temperature (T1) prior to evaporating the first refrigerant and at a second temperature (T2) that is lower than the first temperature (T1) after evaporating the first refrigerant, and wherein the liquid cryogen is used to pre-cool the first coolant when T2 exceeds a predetermined temperature threshold.

6. The process according to claim 5, wherein the liquid cryogen reduces the first temperature (T1) of the first coolant by at least about 3° C. to produce a pre-cooled coolant.

7. The process according to claim 3, wherein the cold dry gas is boil-off gas from a stored liquid cryogen.

8. The process according to claim 3, wherein the liquid cryogen is selected from the group consisting of liquid nitrogen, liquid air, liquid argon, and liquid oxygen.

9. The process according to claim 3, wherein the liquid cryogen is liquid nitrogen.

10. The process according to claim 3, wherein the liquid cryogen is generated on site in a cryogenic air distillation and/or liquefaction unit, or removed from a cryogenic energy storage unit.

11. The process according to claim 2, wherein the cold dry gas provides at least 0.5 MW of additional refrigeration duty.

12. The process according to claim 4, wherein the liquid cryogen is used at a rate of at least 5 tonnes/h.

13. The process according to claim 1, wherein the first coolant is selected from a group consisting of water, glycol, and mixtures thereof.

14. The process according to claim 1, wherein the closed loop cooling circuit is for cooling at least a section of a data center.

15. An apparatus for providing additional refrigeration duty in a closed loop mechanical refrigeration cycle for cooling a first coolant circulating in a closed loop cooling circuit, said apparatus comprising:
a closed loop mechanical refrigeration cycle comprising:
an evaporator configured to evaporate expanded refrigerant by heat exchange against a first coolant circulating in a closed loop cooling circuit to produce evaporated refrigerant, said evaporator in fluid flow communication with a compressor configured to compress the evaporated refrigerant to produce compressed refrigerant, said compressor in fluid flow communication with an air-cooled condenser unit configured to condense the compressed refrigerant by heat exchange against air to produce condensed refrigerant, said air-cooled condenser unit in fluid flow communication with an expander configured to the expand the condensed refrigerant to produce expanded refrigerant, said expander being in fluid flow communication with the evaporator;
a source of cold and/or dry gas; and
at least one nozzle in fluid flow communication with the source of cold and/or dry gas for adding cold and/or dry gas into air passing through the air-cooled condenser unit.

16. The apparatus according to claim 15, wherein the cold and/or dry gas is a cold dry gas and the source of cold dry gas is a heat exchanger located upstream of the evaporator and configured to vaporize a liquid cryogen against the first coolant prior to the first coolant being fed to the evaporator.

17. The apparatus according to claim 16, further comprising a unit for supplying liquid cryogen, said unit being in fluid flow communication with the heat exchanger.

18. The apparatus according to claim 15, wherein the closed loop cooling circuit is configured and located to cool at least a section of a data center.

19. A data center comprising computer equipment and an apparatus according to claim 15 for air-cooling said computer equipment.
